(19) United States
(12) Patent Application Publication
(10) Pub. No.: US 2016/0259371 A1
(43) Pub. Date: Sep. 8, 2016

(54) METHOD FOR MOUNTING AN ELECTRONIC TABLET ONTO CUSTOM FRAME MOULDING

(71) Applicant: MOUNTAINCOW, LLC, Providence, RI (US)

(72) Inventors: Joshua M. Eisen, Providence, RI (US); Megan E. Eisen, Providence, RI (US)

(73) Assignee: MOUNTAINCOW, LLC, Providence, RI (US)

(21) Appl. No.: 15/059,408

(22) Filed: Mar. 3, 2016

Related U.S. Application Data
(60) Provisional application No. 62/127,304, filed on Mar. 3, 2015.

(51) Int. Cl. G06F 1/16; A47G 1/06; A47G 1/14

(52) U.S. Cl. CPC G06F 1/1626; A47G 1/143; A47G 1/0616

(57) ABSTRACT

A frame for a tablet computer is disclosed. The frame includes a frame moulding with left, right, top and bottom elements joined together and sized and dimensioned to form a generally rectangular frame aperture. The frame moulding further includes front and rear faces. A rabbet is formed on the rear face of the frame moulding about the frame aperture. A liner is configured and arranged to insert into the rabbet. The liner has a thickness of about a depth of the rabbet. A pair of opposing rails is attached to the frame moulding. The rails are configured and arranged to hold a tablet computer between the rails and the frame moulding.

### BACKGROUND

1. Technical Field

The present patent document relates generally to frames and more specifically to a decorative frame for mounting onto an electronic tablet or tablet computer.

2. Background of the Related Art

Digital picture frames are known in the art. Theses digital picture frames are single use devices and the selection of frame mouldings is limited and not interchangeable. Further, many digital picture frames are unattractive and do not match the user's home decor. Further, many users that own tablet computers have them idle much of the time, being used for no purpose. Or older devices that the user has since upgraded to a newer device, have lost their purpose.

Therefore, there is a perceived need in the industry for a digital picture frame that enables a user to have a custom frame moulding that the user finds aesthetically pleasing. Further, there is a perceived need in the art for a user to be able to put their tablet computer to use when not actively using the tablet, or repurpose a retired device.

### SUMMARY

The custom frame and method described herein solves the problems of the prior art by providing a frame that includes a fabric-covered liner configured to fit the rabbet of frame moulding and provide a flat back surface upon which to attach a pair of rails connected to the rear face of the frame and adjacent to the frame aperture. The rails are sized and dimensioned to hold the sides and bottom edges of the tablet computer securely to the frame while allowing the tablet computer to be inserted into and subsequently removed from the frame without disassembly of the frame. A frame backing with an optional kickstand is inserted into the rails and further secures the tablet computer to the frame. An optional cello bag photo holder may be included with the frame to take the place of the tablet computer when the tablet computer is being used. An optional adapter for thinner tablets may be provided to secure the thinner tablets to the frame.

The method enables the displaying of digital photos throughout the home by pairing electronic tablets with decorative frame mouldings. The custom frame industry is well established with hundreds of thousands of pre-existing mouldings that can now be repurposed to frame electronic tablets to display digital photos using the invention. The invention provides a huge advantage over custom manufacturing of specific mouldings any custom manufactured product would be limited to the styles manufactured for that specific purpose while the invention allows access to all currently existing moulding styles and all currently existing electronic tablet models. No new manufacturing standards or facilities are required and custom frame shops can use existing materials and procedures to produce exceptional quality frames for electronic tablets.

### BRIEF DESCRIPTION OF THE DRAWINGS

These and other features, aspects, and advantages of the present invention will become better understood with reference to the following description, appended claims, and accompanying drawings where:

FIG. 1 is a front view of a frame for mounting an electronic tablet;

FIG. 2A is an illustration showing a rear perspective view of a frame for holding an electronic tablet;

FIG. 2B is an exploded view of a frame for holding an electronic tablet;

FIG. 3 is a top, front perspective view of a frame for mounting an electronic tablet;

FIG. 4 is a top, rear perspective view of a frame for mounting an electronic tablet;

FIG. 5 is a rear view of a frame for mounting an electronic tablet;

FIG. 6 is a rear view of a frame for mounting an electronic tablet, with the backing removed;

FIG. 7 is a top, rear perspective view of a frame for mounting an electronic tablet with the backing removed; and

FIG. 8 a flow chart of a method of mounting an electronic tablet in a custom frame moulding is shown.

### DESCRIPTION OF THE PREFERRED EMBODIMENT

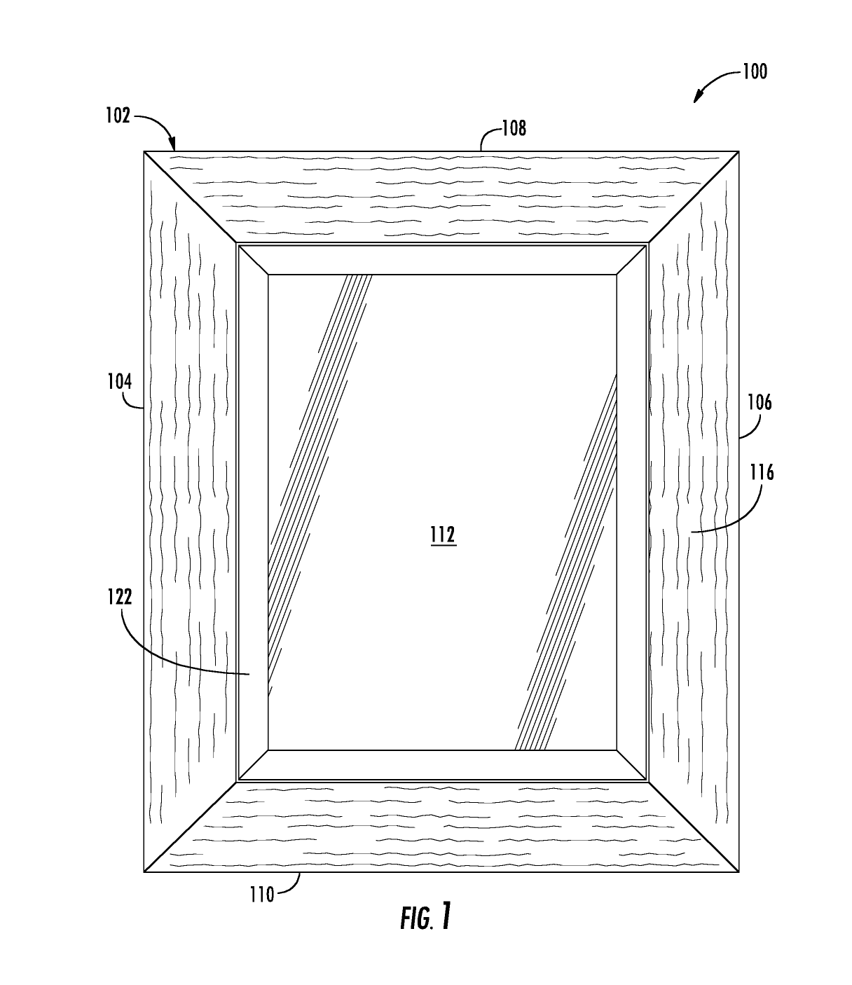

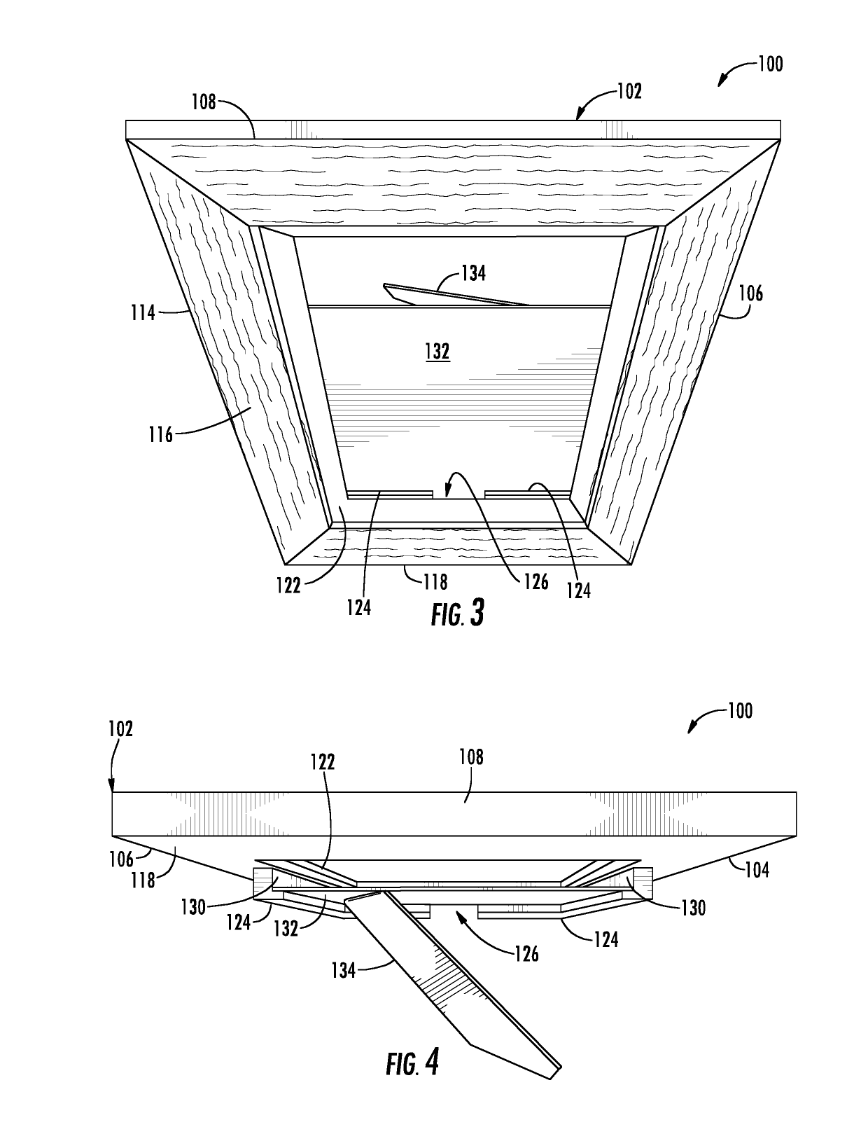

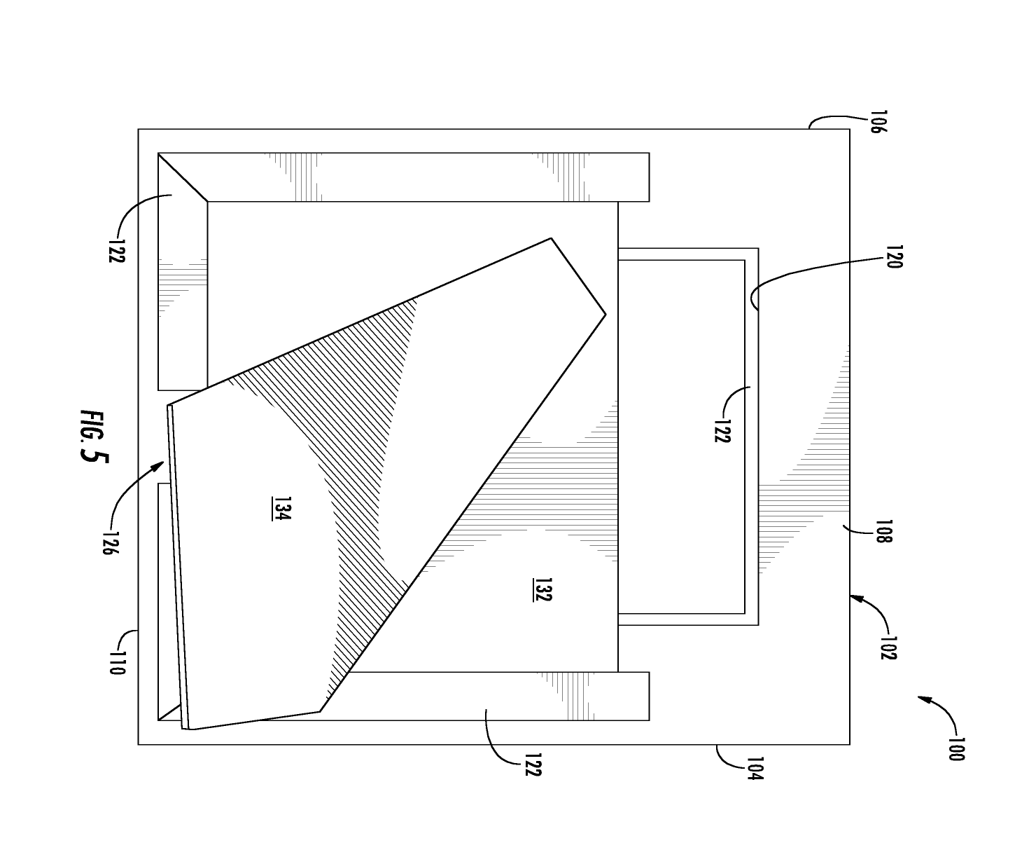

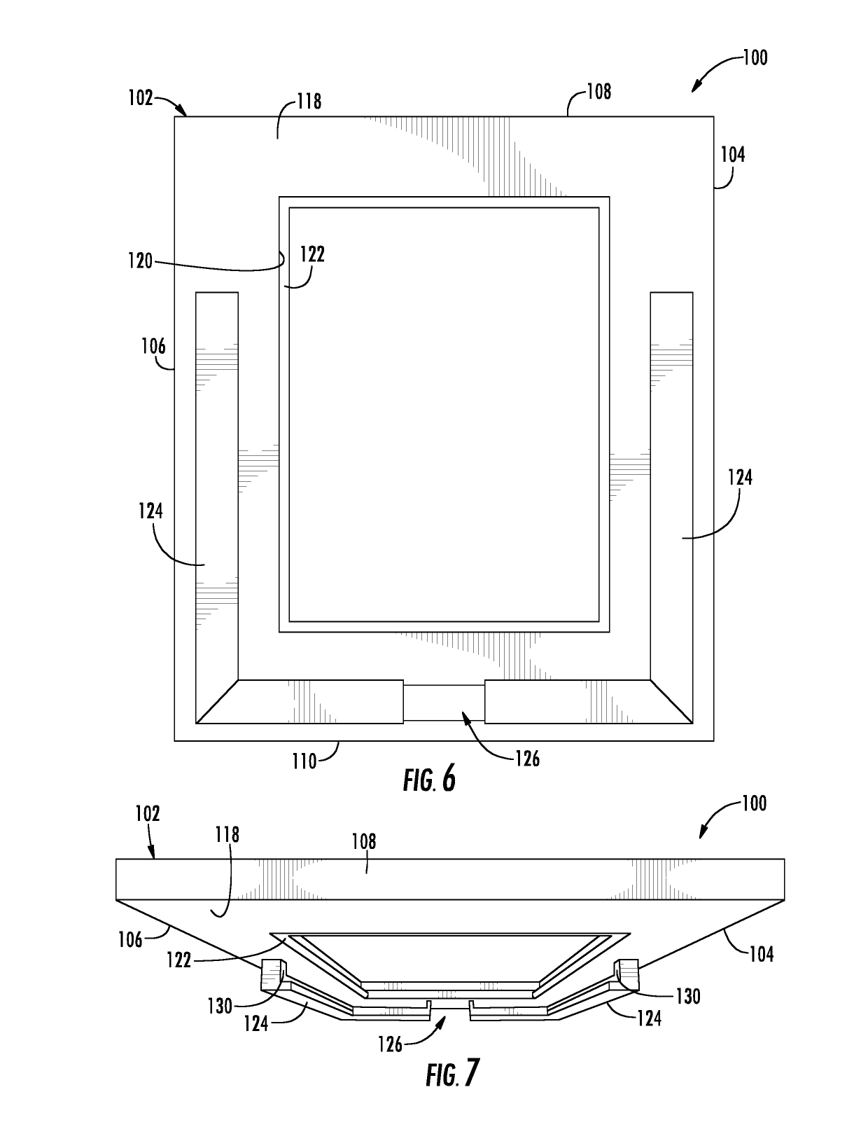

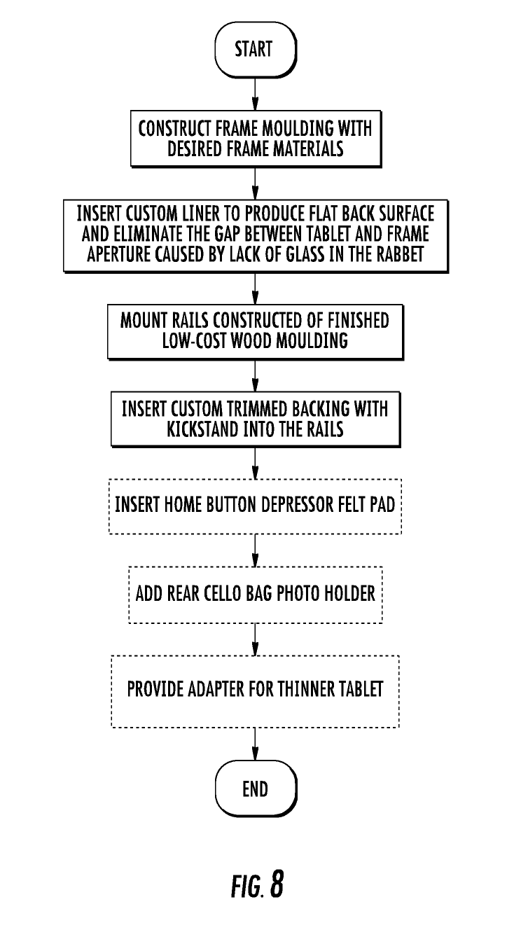

Referring now to FIG. 1-7, an exemplary embodiment of the frame for an electronic tablet is shown generally at 100. As will be described in greater detail below, the frame includes a liner configured to fit the rabbet of the frame, a pair of opposed L-shaped rails configured to hold an electronic tablet, a backing with an optional kickstand configured to insert into the rails.

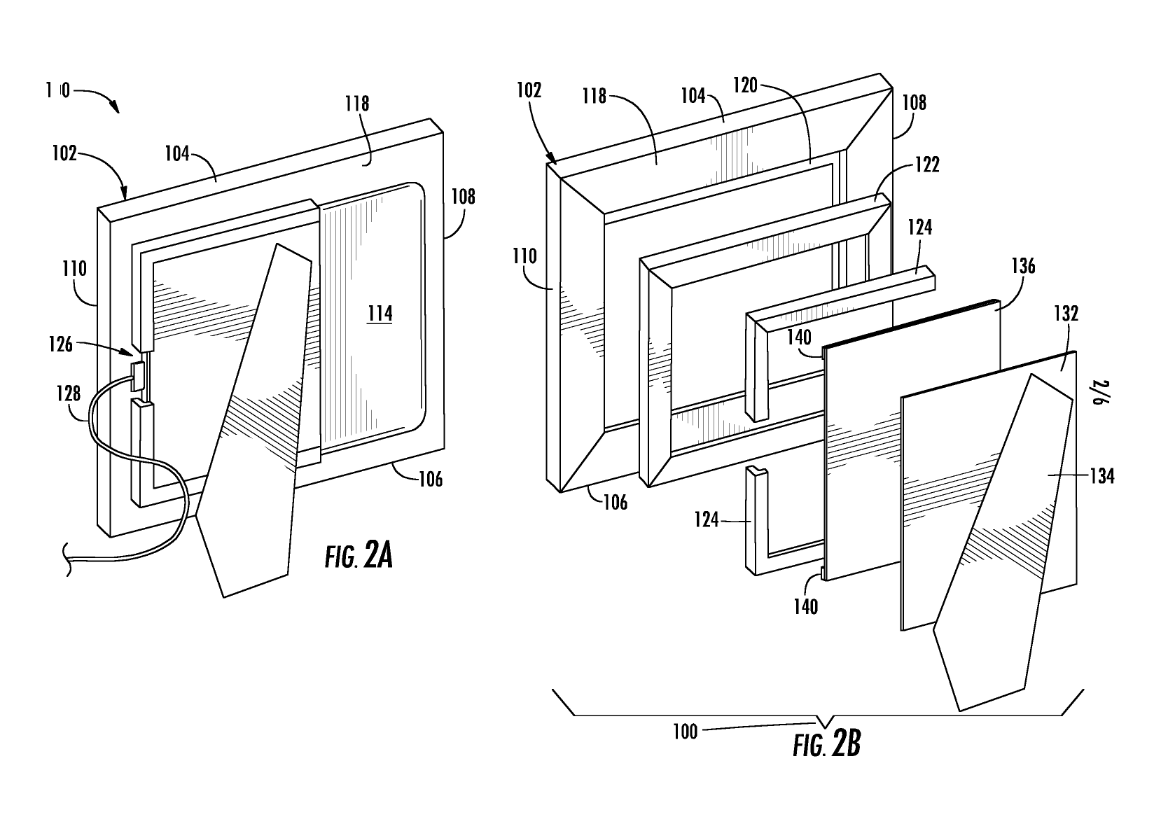

The frame 100 includes a frame moulding 102 with left 104, right 106, top 108 and bottom 110 elements joined together and sized and dimensioned to form a generally rectangular frame aperture through which a screen 112 of an electronic tablet (or tablet computer) 114 may be viewed. The frame moulding 102 further includes a front 116 and rear faces 118. The front face 116 of the frame moulding 102 may have a decorative profile to enhance the aesthetic appeal of the frame. On the rear face 118, a rabbet 120 is formed on the frame moulding 102 about the frame aperture (best seen in FIG. 2B). A fabric covered liner 122 having a thickness of about the depth of the rabbet 120 in the frame moulding 102, is inserted into the rabbet 120. The fabric may be linen or any other cloth as desired.

Two L-shaped rails 124 are secured to the rear face 118 of the frame moulding 100, opposing one another and collectively bordering three elements of the frame moulding 102. A gap 126 is formed between the nearest parts of the rails 124, forming a space for an electrical cable 128 to connect to the electronic tablet 114. Each rail includes secondary rabbet 130 configured to hold the electronic tablet 114. The rails 124 extend about one-half to about three-quarters the length of the frame moulding 102. The electronic tablet 114 may be easily slid into and out of the rails 124.

A backing 132 with an optional kickstand 134 may be inserted into the rails 124 and behind the electronic tablet 114, to provide additional security to the electronic tablet 114 and allow the frame 100 to be place on a flat surface, such as a desk, credenza or shelf. One or more hooks, loops or wires may also be provided on the rear face 118 of the frame 100 or rails 124 to enable wall hanging.

An optional adapter 136 for thinner electronic tablets 114 may be provided to ensure a secure fit of thinner tablet 114 within the rails 124. The adapter 135 may include optional rail guides 140 for thinner tablets 114.

If the user desires to use the tablet 114, but desire to avoid the unpleasing sight of an empty frame 100, an optional cello photo bag may be provided to insert a photo in the electronic tablet's 114 place in the rails 124.

Referring to FIG. 8, a flowchart of a method of mounting an electronic tablet into a custom frame moulding 102 is shown generally. After selecting and assembling the frame stock into a frame moulding 102, the gap between tablet 114 and aperture caused by lack of glass in the rabbet 120 is eliminated. By pairing a fabric-covered liner 122 with the custom frame moulding 102 sized to fit the rabbet 120, or by planing off the excess rear protrusion of the liner 122, a flat rear surface is achieved on the custom frame moulding 102 while producing a pleasing graduated intermediary joining the edge of the moulding down to the surface of the electronic tablet 114. The flat rear surface 118 allows for the mounting of rails 124 and lining with felt that enable the electronic tablet 114 to easily slide in and out of the frame 100.

Next, the rails 124 are mounted. The rails 124 are constructed of finished low-cost wood moulding. Rails 124 in the form of two L-shaped sides extend partially up the length of the frame 100 to hold the tablet 114 in place behind the frame 100. The rails 124 are connected at one end to an additional rail to stop the electronic tablet 114 from sliding all the way through and they include a gap 126 for the electronic tablet's 114 A/C charging cable 128 connector. The rails 124 are lined with felt for easy insertion and removal.

Next, a custom trimmed backing 132 with optional kickstand 134 is inserted into the rails 124. By using a standard chipboard kickstand backing trimmed to a custom size we can enable any device 114 in any size moulding 102 to be displayed standing in portrait or landscape configuration. The backing 132 with kickstand 134 stays in place during device insertion and removal by virtue of being cut 1/16″ too wide for the rails 124 and being pressure-fit inserted into place, glued or otherwise fastened.

Optionally, a “home” button depressor felt pad may be inserted. By adhering a small round felt pad to the back of the moulding 102 the invention enables depressing of the home button while the electronic tablet 114 is inserted in the frame 100.

Optionally, a rear cello bag photo holder may be added. By inserting a printed photo into a cello plastic display bag and inserting it in place of the electronic tablet 114, the invention enables display of a photo when the electronic tablet 114 is removed from the frame for other uses.

Optionally, an adapter 136 for thinner tablets 114 may be provided. By providing removable chipboard inserts with their own chipboard rail guides, the same frame can be adapted to accommodate different width and depth tablet devices with the same screen aperture and device length. The consumer can insert or remove these inserts as desired. The adapter stays in place during device insertion and removal by virtue of being cut 1/16″ too wide for the rails and being pressure-fit inserted into place.

Therefore, it can be seen the frame and method described herein provides a useful way to repurpose older electronic tablets and put to use idle electronic tablets, yet provides an infinite selection of custom frame mouldings unavailable to single purpose digital picture frames.

It would be appreciated by those skilled in the art that various changes and modifications can be made to the illustrated embodiments without departing from the spirit of the present invention. All such modifications and changes are intended to be within the scope of the present invention.

What is claimed:

1. A frame for a tablet computer, comprising:
a frame moulding with left, right, top and bottom elements joined together and sized and dimensioned to form a generally rectangular frame aperture, the frame moulding further including front and rear faces;
a rabbet formed on the rear face of the frame moulding about the frame aperture;
a liner configured and arranged to insert into the rabbet, the liner having a thickness of about a depth of the rabbet; and
a pair of opposing rails attached to the frame moulding, the rails configured and arranged to hold a tablet computer between the rails and the frame moulding.

2. The frame of claim 1, wherein the rails are L-shaped.

3. The frame of claim 1, wherein each rail includes a secondary rabbet configured and arranged to hold an edge of the tablet computer.

4. The frame of claim 1, wherein the rails are spaced apart, including a gap forming a space for an electrical cable to connect to the electronic tablet.

5. The frame of claim 1, wherein the rails extend about one-half to about three-quarters the length of the frame moulding.

6. The frame of claim 1, wherein the liner is covered in fabric.

7. The frame of claim 1, wherein the front face of the frame moulding has a decorative profile.

8. The frame of claim 1, further comprising a backing configured and arranged to insert into the rails behind and behind a tablet computer.

9. The frame of claim 1, wherein the backing includes a kickstand.

10. The frame of claim 1, wherein the kickstand is folding.

11. The frame of claim 1, wherein the rails are felt lined.

12. A method of mounting a tablet computer in a frame, comprising:
constructing a frame moulding with desired frame materials, frame moulding having left, right, top and bottom elements joined together and sized and dimensioned to form a generally rectangular frame aperture, the frame moulding further including front and rear faces, the frame moulding having a rabbet formed on the rear face of the frame moulding about the frame aperture
inserting a liner to produce flat back surface and eliminate a gap between a tablet computer and the frame; and
mounting rails to the frame moulding.

13. The method of claim 12, further comprising inserting a backing into the rails behind the tablet computer.

14. The method of claim 12, further comprising inserting a “home” button depressor felt pad to the rear of the frame moulding.

15. The method of claim 12, further comprising inserting a cello bag photo holder in place of the electronic tablet

16. The method of claim 12, further comprising providing removable chipboard inserts with complimentary chipboard rail guides for accommodating different width and depth tablet computer devices within the frame moulding.

17. The method of claim 12, further comprising lining the rails with felt.
